(19) United States
(12) Patent Application Publication
(10) Pub. No.: US 2015/0324704 A1
(43) Pub. Date: Nov. 12, 2015

(54) METHOD AND APPARATUS FOR PARTICIPATORY SENSING DATA COLLECTION

(71) Applicant: NOKIA CORPORATION, Espoo (FI)

(72) Inventors: Junsong ZHANG, Beijing (CN); Liu YAZHI, Beijing (CN); Ma JIAN, Beijing (CN); Tian YE, Beijing (CN); Li XIONG, Beijing (CN)

(73) Assignee: Nokia Corporation

(21) Appl. No.: 14/412,598

(22) PCT Filed: Jul. 26, 2013
(86) PCT No.: PCT/FI2013/050774

§ 371 Date: Jan. 2, 2015

(30) Foreign Application Priority Data
Jul. 27, 2012 (CN) 201210268216.7

(51) Int. Cl. G06N 7/00; G06N 5/02

(52) U.S. Cl. CPC G06N 7/005; G06N 5/02

(57) ABSTRACT

Embodiments of the present invention disclose a method and apparatus for participating in sensing data collection. The method comprises: for each of multiple user equipments, calculating probabilities that the user equipment is located in respective subareas of a predetermined area at a predetermined time by using historical movement information of the user equipment; determining types of sensing data to be collected when the user equipment is located in the respective subareas, based on capability information of the user equipment for collecting sensing data; and obtaining a utility value of the user equipment associated with sensing data collection within the predetermined area, based on the probabilities calculated for the respective subareas and the determined types of sensing data. The method further comprises selecting one or more user equipments from the multiple user equipments for collection of participatory sensing data, based on multiple utility values obtained for the multiple user equipments. By means of the method and apparatus according to the embodiments of the present invention, it is possible to efficiently select user equipments participating in sensing data collection, increase the efficiency for sensing data collection, and reduce the cost for data collection.

### FIELD OF THE INVENTION

Exemplary embodiments of the present invention generally relate to collection of sensing data, and more specifically relate to a method and apparatus for participatory sensing data collection.

### BACKGROUND OF THE INVENTION

Along with the continuous evolution and development of mobile communication technology, current user equipments (for example, a mobile terminal including a smart phone) have evolved from having only a single voice call function to having various complex multimedia applications. By means of the advantages brought by the mobile communication technology and their ubiquity, various types of sensors equipped in user equipments may be used to implement a large-scale sensing data collection. For example, a built-in camera of a user equipment may serve as an image sensor to collect (or sense) image information of surrounding environments to thereby form sensing data about images. For another example, a microphone of a user equipment may serve as a sound sensor to collect sound information of the area where the user equipment is located to thereby form sensing data about sounds. Similarly, an embedded GPS receiver of a user equipment may serve as a location sensor to collect location information of the area where the user equipment is located to thereby form sensing data about locations. Predictably, along with the development of sensing technology and the continuous improvement of the integration level of electronic devices, various types of sensors will be integrated into or built in the future user equipments, such as a temperature sensor, a humidity sensor, and even a PM 2.5 sensor for monitoring air quality so as to collect various types of sensing data.

An important aspect of participating in the above sensing data collection (or participatory sensing data collection) lies in enabling users to use their user equipments to collect sensing data from surrounding environments and to upload or share the collected sensing data. An application system for participatory sensing data collection is generally constructed in a centralized manner. Simply speaking, firstly the user equipment participating in sensing data collection uses equipped various sensors to collect several types of data in the area where it is located to form sensing data, and then report these sensing data via wireless data communication links (e.g. via a wireless network or a WiFi network) to a central data server for storage. Thereafter, various types of application servers provided, for example, by operators may obtain the centrally stored sensing data from the central data server, and provide various services based on these sensing data, for example, a location based service, a recommendation service, a reminding service, an air quality monitoring or road traffic monitoring service, etc.

In order to provide comprehensive, extensive and accurate services, the central data server acting as a sensing data agency usually expects that user equipments participating in a sensing application can continuously provide collected sensing data to the central data server, and further expects the diversity of the collected sensing data types. However, since the data sensing capabilities of user equipments are different and the sensed data types are limited, it is not practical to collect all types of sensing data based on a specific user equipment. A straightforward way to solve this problem is to invite more user equipments to participate in the sensing data collection, but in most cases, in order to motivate users to join in the participatory sensing data collection, the operator of the central data server needs to pay a certain fee to the participants, while more participants mean higher cost for data collection and more consumption of network resources.

Therefore, how to efficiently select a reasonable number of user equipments to collect sensing data in a larger geographical coverage and with a stronger sensing capability so as to reduce the cost for sensing data collection and meanwhile increase the efficiency of data collection is an important issue to be addressed in the current participatory sensing data collection system.

### SUMMARY OF THE INVENTION

For the existing problems in the prior art, embodiments of the present invention provide a mechanism for efficiently selecting user equipments participating in sensing data collection so as to select an appropriate number of user equipments to carry out participatory sensing data collection.

According to one exemplary embodiment of the present invention, there is provided a method. The method comprises, for each of multiple user equipments, calculating probabilities that the user equipment is located in respective subareas of a predetermined area at a predetermined time by using historical movement information of the user equipment. The method further comprises determining types of sensing data to be collected when the user equipment is located in the respective subareas, based on capability information of the user equipment for collecting sensing data. In addition, the method comprises obtaining a utility value of the user equipment associated with sensing data collection within the predetermined area, based on the probabilities calculated for the respective subareas and the determined types of sensing data. Further, the method comprises selecting one or more user equipments from the multiple user equipments for collection of participatory sensing data, based on multiple utility values obtained for the multiple user equipments.

In one embodiment, the method further comprises receiving and storing location information about movement of the user equipment among the respective subareas and the capability information for collecting sensing data before calculating the probabilities.

In another embodiment, calculating probabilities that the user equipment is located in respective subareas of a predetermined area at a predetermined time by using historical movement information of the user equipment comprises: building a Markov chain model based on the historical movement information, wherein the historical movement information relates to statistical information on location transfer of the user equipment among the respective subareas and stay time of the user equipment in the respective subareas; and calculating the probabilities that the user equipment is located in the respective subareas of the predetermined area at the predetermined time by using the Markov chain model.

In yet another embodiment, the method determines types of sensing data to be collected when the user equipment is located in a subarea, based on types of sensing data that can be collected when the user equipment moves to the subarea and types of sensing data that have been collected previously in the subarea and have not expired.

In yet another embodiment, selecting one or more user equipments from the multiple user equipments for collection of participatory sensing data, based on multiple utility values obtained for the multiple user equipments further comprises one of the following operations: comparing each of the multiple utility values with a predetermined threshold; and sorting the multiple utility values.

In yet another embodiment, the method further comprises: after selecting user equipments that will participate in sensing data collection, notifying the user equipments to perform the sensing data collection; and receiving and storing sensing data that are collected by the user equipment within the predetermined area.

In yet another embodiment, execution of the method is triggered by an event, a cycle or a request.

In yet another embodiment, the utility value is obtained with a formula as below:

$${U}_{α} = {\sum }_{{L}_{i}} {\int }_{t = 0}^{Δ T} {p}_{Li}^{t} ( α ) \vert {C}_{{L}_{i}}^{α} - {A}_{{L}_{i}}^{t} \vert d t$$

where U_{α} denotes the utility value of user equipment α; Lᵢ denotes the i-th subarea; ΔT denotes a cycle for selecting user equipments to participate in the sensing data collection; p_{Li}^{t}(α) denotes a probability that the user equipment α is located in the subarea Lᵢ at a predetermined time t; C_{L}_{ᵢ}^{α} denotes a set of the types of sensing data that can be provided by the user equipment α in the subarea Lᵢ; A_{L}_{ᵢ}^{t} denotes a set of the types of sensing data that are recorded in the subarea Lᵢ and are not expired at the predetermined time t.

In any of the above embodiments, the sensing data comprise sensing data that are collected by the user equipment and relate to at least one type of humidity, temperature, air quality, location, brightness, vibration, sound and scene of the respective subareas.

According to another exemplary embodiment of the present invention, there is provided a method. The method comprises sending location information of a user equipment so that probabilities that the user equipment is located in respective subareas of a predetermined area at a predetermined time are calculated by using historical movement information formed from the location information. The method further comprises sending capability information of the user equipment for collecting sensing data so that types of sensing data to be collected when the user equipment is located in the respective subareas are determined. In addition, the method comprises receiving a notification about selecting the user equipment to participate in sensing data collection in the predetermined area. Further, the method comprises participating in the sensing data collection in the predetermined area in response to receipt of the notification, wherein the selecting is based on a utility value of the user equipment associated with the sensing data collection within the predetermined area, and the utility value is obtained based on the probabilities calculated for the respective subareas and the determined types of sensing data.

According to yet another exemplary embodiment of the present invention, there is provided an apparatus. The apparatus comprises at least one processor and at least one memory containing computer program code. The processor and the memory are configured to, with the processor, cause the apparatus to at least execute, for each of multiple user equipments, calculating probabilities that the user equipment is located in respective subareas of a predetermined area at a predetermined time by using historical movement information of the user equipment. The processor and the memory are further configured to, with the processor, cause the apparatus to at least execute, for each of multiple user equipments, determining types of sensing data to be collected when the user equipment is located in the respective subareas, based on capability information of the user equipment for collecting sensing data. In addition, the processor and the memory are further configured to, with the processor, cause the apparatus to at least execute, for each of multiple user equipments, obtaining a utility value of the user equipment associated with sensing data collection within the predetermined area, based on the probabilities calculated for the respective subareas and the determined types of sensing data. Further, the processor and the memory are further configured to, with the processor, cause the apparatus to select one or more user equipments from the multiple user equipments for collection of participatory sensing data, based on multiple utility values obtained for the multiple user equipments.

According to yet another exemplary embodiment of the present invention, there is provided an apparatus. The apparatus comprises at least one processor and at least one memory containing computer program code, the processor and the memory configured to, with the processor, cause the apparatus to at least execute sending location information of a user equipment so that probabilities that the user equipment is located in respective subareas of a predetermined area at a predetermined time are calculated by using historical movement information formed from the location information. The processor and the memory are configured to, with the processor, cause the apparatus to at least execute sending capability information of the user equipment for collecting sensing data so that types of sensing data to be collected when the user equipment is located in the respective subareas are determined. In addition, the processor and the memory are configured to, with the processor, cause the apparatus to at least execute receiving a notification about selecting the user equipment to participate in sensing data collection in the predetermined area. Further, the processor and the memory are configured to, with the processor, cause the apparatus to at least execute participating in the sensing data collection in the predetermined area in response to receipt of the notification, wherein the selecting is based on a utility value of the user equipment associated with the sensing data collection within the predetermined area, and the utility value is obtained based on the probabilities calculated for the respective subareas and the determined types of sensing data.

According to yet another exemplary embodiment of the present invention, there is provided an apparatus. The apparatus comprises the following devices configured to execute operations for each of multiple user equipments: a calculating device configured to calculate probabilities that the user equipment is located in respective subareas of a predetermined area at a predetermined time by using historical movement information of the user equipment; a determining device configured to determine types of sensing data to be collected when the user equipment is located in the respective subareas, based on capability information of the user equipment for collecting sensing data; and an obtaining device configured to obtain a utility value of the user equipment associated with sensing data collection within the predetermined area, based on the probabilities calculated for the respective subareas and the determined types of sensing data. The apparatus further comprises a selecting device configured to select one or more user equipments from the multiple user equipments for collection of participatory sensing data, based on multiple utility values obtained for the multiple user equipments.

According to yet another exemplary embodiment of the present invention, there is provided an apparatus. The apparatus comprises a first sending device configured to send location information of a user equipment so that probabilities that the user equipment is located in respective subareas of a predetermined area at a predetermined time are calculated by using historical movement information formed from the location information. The apparatus further comprises a second sending device configured to send capability information of the user equipment for collecting sensing data so that types of sensing data to be collected when the user equipment is located in the respective subareas are determined. In addition, the apparatus comprises a receiving device configured to receive a notification about selecting the user equipment to participate in sensing data collection in the predetermined area. Further, the apparatus comprises a collecting device configured to participate in the sensing data collection in the predetermined area in response to receipt of the notification, wherein the selecting is based on a utility value of the user equipment associated with the sensing data collection within the predetermined area, and the utility value is obtained based on the probabilities calculated for the respective subareas and the determined types of sensing data.

According to yet another exemplary embodiment of the present invention, there is provided a computer program product, comprising at least one computer readable storage medium having a computer readable program code portion stored therein, wherein the computer readable program code portion is configured for executing the method for participatory sensing data collection according to the exemplary embodiments of the present invention.

According to yet another exemplary embodiment of the present invention, there is provided a computer program product, comprising at least one computer readable storage medium having a computer readable program code portion stored therein, wherein the computer readable program code portion is configured for executing the method for participatory sensing data collection according to other embodiments of the present invention.

According to some exemplary embodiments of the present invention, by using historical location information of user equipments, it is possible to efficiently predict movement traces of the user equipments that will participate in sensing data collection. Further, by obtaining utility values that can be achieved by the user equipments to execute sensing data collection within a predetermined area, it is possible to efficiently select user equipments having good utility values to participate in the sensing data collection, excluding those user equipments that cannot efficiently collect data. This not only efficiently reduces the consumption of network resources, but also increases the efficiency for sensing data collection, and meanwhile greatly reduces the cost of data collection.

### BRIEF DESCRIPTION OF THE DRAWINGS

Other features, objectives and advantages of the present invention will become more obvious by making references to the following detailed description of non-limiting embodiments of the present invention in conjunction with the accompanying drawings. In the accompanying drawings, the same or similar reference numerals refer to the same or similar apparatus or method steps, in which:

FIG. 1 schematically illustrates a system architecture diagram in which a method and apparatus according to exemplary embodiments of the present invention can be applied;

FIG. 2 schematically illustrates a flowchart of a method for participatory sensing data collection according to one embodiment of the present invention;

FIG. 3 schematically illustrates a flowchart of a method for participatory sensing data collection according to another embodiment of the present invention;

FIG. 4 schematically illustrates an operation diagram of an example for participatory sensing data collection according to embodiments of the present invention;

FIG. 5 schematically illustrates an entity interaction diagram among a user equipment, a sensing data agency and a service provider for participatory sensing data collection according to embodiments of the present invention;

FIG. 6 schematically illustrates a block diagram of an apparatus for participatory sensing data collection according to one embodiment of the present invention;

FIG. 7 schematically illustrates a block diagram of an apparatus for participatory sensing data collection according to another embodiment of the present invention; and

FIG. 8 schematically illustrates a block diagram of an apparatus for participatory sensing data collection according to another embodiment of the present invention.

### DETAILED DESCRIPTION OF EMBODIMENTS

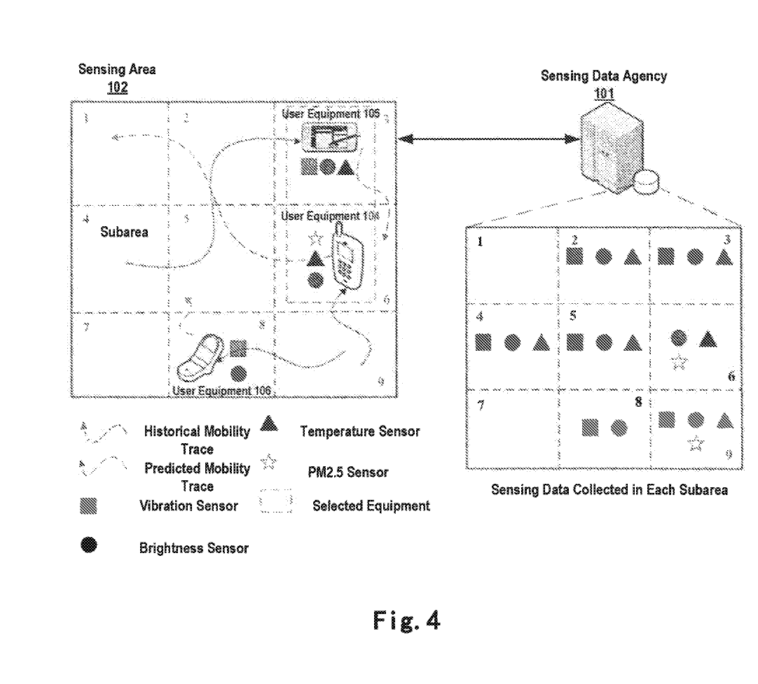

In order to implement efficient participatory sensing data collection, exemplary embodiments of the present invention provide an efficient solution regarding how to select a number of appropriate user equipments from multiple user equipments to participate in sensing data collection. Thus, historical mobility information (or referred to as historical movement trace as shown in FIG. 4) of multiple user equipments may be used to predict probabilities that each user equipment is located in respective subareas of a predetermined area at a predetermined time.

It shall be noted that the term “a predetermined time” used herein does not refer to a specific time point or a specific time instant, such as a specific time in 24 hours of a day, but is intended to express that a determined time period (e.g. a cycle ΔT for executing selection of user equipments to participate in sensing data collection) is divided in advance into multiple time lengths by a certain time unit (also called unit time slot or time length). Correspondingly, the probabilities that a user equipment is located in a certain subarea within respective predetermined time lengths (such as 1 time length, 2 time lengths, . . . , and so on) are probabilities to stay in the subarea for respective time lengths. For example, suppose the cycle ΔT=1 hour and the unit time length is 20 minutes, the time period of 1 hour can be divided into a first time length (0˜20 minutes), a second time length (20˜40 minutes) and a third time length (40˜60 minutes). Further, if it is estimated that a user equipment stays in a certain subarea for 35 minutes, the probability that the user equipment is located in the subarea at a predetermined time (i.e. the second time length) can be calculated according to the present invention. Regarding the predetermined time, it will be described later in conjunction with specific embodiments.

Next, it is possible to determine types of sensing data that can be collected when a user equipment moves to respective subareas. In another embodiment, it can be considered which types of sensing data in a subarea at that time have expired, and once the sensing data have expired and the user equipment supports collecting that type of sensing data, it can be determined that the user equipment can collect that type of sensing data in the subarea.

Through the above prediction and determination, it is possible to obtain utility values for respective user equipments within the entire predetermined area to execute sensing data collection. In one embodiment, the utility values can be obtained by a utility function that takes the above probability and the determined types of sensing data as parameters. In another embodiment, based on the obtained utility values and by comparing with a predetermined threshold or sorting multiple utility values, a number of appropriate user equipments can be selected from multiple user equipments to participate in sensing data collection in a future predetermined time period.

Exemplary embodiments of the present invention will be described below in detail with reference to the accompanying drawings.

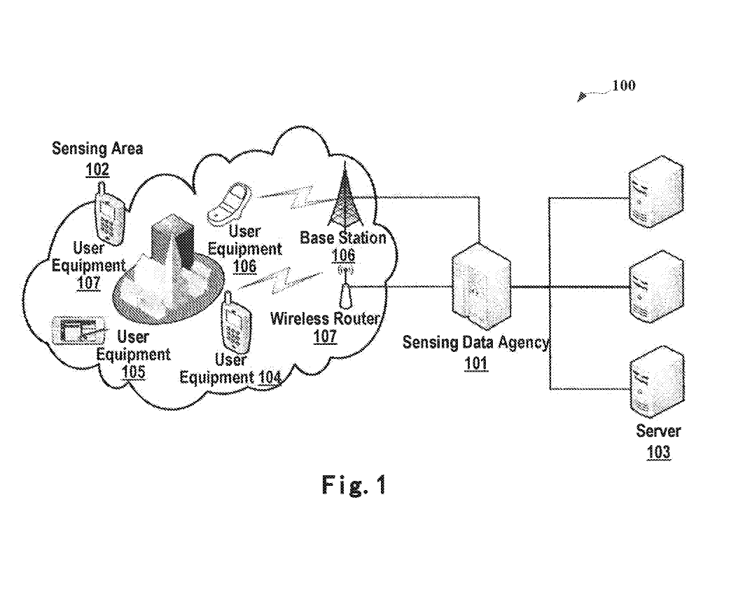

FIG. 1 schematically illustrates a system architecture diagram 100 in which a method and apparatus according to exemplary embodiments of the present invention can be applied. As illustrated in FIG. 1, the system 100 comprises a sensing data agency 101, a server 103, a sensing area 102 indicated as a cloud, four user equipments 104-107 executing sensing data collection within the sensing area 102, a base station 108 and a wireless router 109, both of which can transfer the sensing data that are collected or measured by the user equipments 104-107 to the sensing data agency 101 through an existing wireless communication network (such wireless communication network as GSM, WCDMA, CDMA2000 and TD-WCDMA) and a wireless local network (such as a local network supporting WiFi). The server 103 may be a back-end server for the sensing data agency 101, and may also be the server of multiple service providers so as to obtain the required sensing data from the sensing data agency 101 and provide various types of services to users by processing these data.

Although user equipments of the present invention are illustrated in the form of a cell phone or a mobile phone in FIG. 1, it should be understood that this is merely exemplary, and the user equipments of the present invention may include, but not limited to, cellular phones, personal digital assistants (PDAs) with wireless communication capability, portable computers with wireless communication capability, image capturing devices with wireless communication capability such as digital cameras, gaming devices with wireless communication capability, music storage and playback devices with wireless communication capability, Internet devices allowing wireless Internet access and browse, and portable units or terminals incorporating the combination of these functions.

It may be further understood that the number of equipments in FIG. 1 is merely exemplary, and those skilled in the art can understand that due to different sizes of the sensing area, a different number of user equipments may be needed to participate in sensing data collection. As described above, in order to collect more sensing data with various types more efficiently, a large number of user equipments will participate in sensing data collection in the sensing area 102.

Although participation of more user equipments mean that more sensing data can be obtained, it will definitely cause too much consumption of network resources (such as bandwidth, frequency), and the effect of collecting data may not be good because the user equipments may collect too much redundant sensing data in the same area, or the user equipments cannot execute, due to the limitation of sensing capability, sensing data collection in the area where data need to be collected. In addition, since a large number of user equipments participate in sensing data collection, the sensing data providers will pay users an additional fee for this, thereby causing increased cost for data collection.

In order to avoid these problems, the sensing data agency 101 according to exemplary embodiments of the present invention will collect user equipments' historical location information and capabilities for collecting sensing data within the predetermined sensing area 102, and thereby predict in which subarea of the sensing area 102 the user equipments may be located in a future predetermined time period (i.e. the time interval for executing selection of user equipments to participate in sensing data collection) and what type of data can be collected so as to obtain utilities of respective user equipments (e.g. user equipments 104-107) to execute sensing data collection in the sensing area 102. For example, this can be obtained by utility values calculated through a utility function. Then, based on the utility values, a limited number of user equipments are selected for participatory sensing data collection.

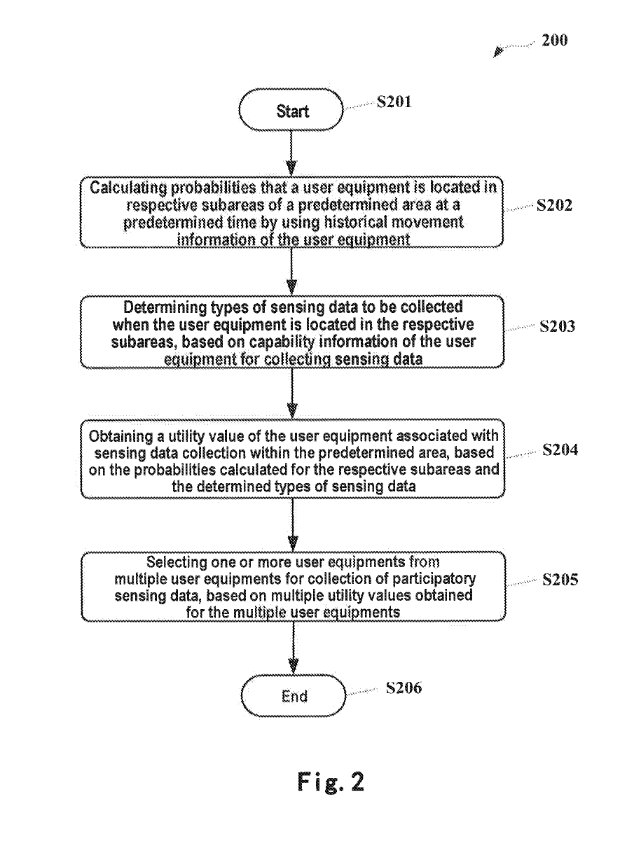

FIG. 2 schematically illustrates a flowchart of a method 200 for participatory sensing data collection according to one embodiment of the present invention. In order to facilitate the understanding of the principle of the present invention, the method 200 will be described in conjunction with the system architecture diagram of FIG. 1.

As illustrated in FIG. 2, the method 200 starts at step S201. Next, for each of multiple user equipments (e.g. for each of the user equipments 104-107), the method 200 at step S202 calculates probabilities that the user equipment is located in respective subareas of a predetermined area (such as the sensing area 102 in FIG. 1) at a predetermined time by using historical movement information of the user equipment.

Although it is not illustrated in the figure, in one embodiment, the method 200 further comprises receiving and storing location information about movement of the user equipment among the respective subareas and capability information for collecting sensing data before calculating the probabilities. For example, the user equipments 104-107 in FIG. 1 may register with the sensing data agency 101, and report, in the registration, to the sensing data agency 101 capabilities for sensing data collection supported by itself. For example, a certain user equipment may report to the sensing data agency 101 that it supports collection of sensing data about the temperature or humidity of surrounding environments. According to another embodiment of the present invention, if the sensing data collection capabilities of a user equipment change, e.g. sensor hardware is updated, the user equipment may also report to the sensing data agency 101 the changed sensing data collection capabilities.

Subsequently, user equipments may report, in real time, periodically or based on a request, to the sensing data agency 101 the location where they are located so that the sensing data agency 101 can form historical movement information of respective user equipments based on the collected location information.

In another embodiment, the method 200 may build a Markov chain model based on the historical movement information when calculating probabilities that the user equipment is located in respective subareas of a predetermined area at a predetermined time, wherein the historical movement information relates to statistical information on location transfer of the user equipment among the respective subareas and stay time of the user equipment in the respective subareas. Then, the probabilities that the user equipment is located in the respective subareas of the predetermined area at the predetermined time can be calculated by using the built Markov chain model.

Specifically, building the Markov chain model may be executed as follows:

Firstly, a matrix P={p_{m,n}} may be defined to denote a transition probability of a user equipment from a subarea Lₘ to Lₙ of a predetermined area. Next, a matrix R={r_{m,σ}} may be defined to denote a probability that the user equipment will stay in the subarea Lₘ for a time lengths (or time units). For each user equipment, matrixes P and R may be calculated based on its historical movement traces.

Then, the state of the user equipment sₜ={L,h} may be defined to denote the state that the user equipment will stay in the subarea L for h time lengths. Similarly, L′ and h′ denote that the user equipment will move to the subarea L′ in the next state and will stay there for h′ time lengths. Therefore, the mobility of the user equipment may be modelled as a Homogeneous Markov chain, and its state transition probability is illustrated in Table 1 below.

TABLE 1
State Transition Probability

| sₜ | sₜ₊₁ | Pr{sₜ₊₁\|sₜ} |
|---|---|---|
| L, h | L, h − 1 | 1 |
| L, 1 | L′, h′ | p_{L, L′} · r_{L′, h′} |

It is assumed that the current time is 0, and the user equipment knows its current location, therefore

Pr{s_{0}=}1 (1);

and the probability that the user equipment is located in the subarea L at a predetermined time t may be expressed as

Pr{sₜ=L}=Pr{sₜ₋₁}Pr{sₜ|sₜ₋₁} (2),

that is, the probability expressed in the utility function (which will be described later in detail) is:

P_{L}^{t}=Pr{sₜ=L} (3).

For another example, the method 200 proceeds to step S203 after calculating, with the Markov chain model, probabilities that the user equipment is located in respective subareas of a predetermined area at a predetermined time. In this step, the method 200 determines types of sensing data to be collected when the user equipment is located in the respective subareas, based on capability information of the user equipment for collecting sensing data. Here, the capability information refers to the fact that the user equipment can sense or collect which types of data, which is generally determined by the types of sensors equipped in the user equipment.

In one embodiment, it is possible to determine types of sensing data to be collected, based on types of sensing data that can be collected when the user equipment moves to a subarea and types of sensing data that have been collected previously in the subarea and have not expired. For example, when a user equipment supporting temperature and humidity sensing data collection moves to a subarea in which the temperature data recorded at the sensing data agency 101 have not expired but the humidity data have expired, it can be determined that the user equipment will collect the humidity type of sensing data.

Next, the method 200 proceeds to step S204. Here, the method 200 obtains a utility value of the user equipment associated with sensing data collection within the predetermined area, based on the probabilities calculated for the respective subareas and the determined types of sensing data.

In one embodiment, the utility value can be obtained by building a utility function below:

$${U}_{α} = {\sum }_{{L}_{i}} {\int }_{t = 0}^{Δ T} {p}_{Li}^{t} ( α ) \vert {C}_{{L}_{i}}^{α} - {A}_{{L}_{i}}^{t} \vert d t \qquad ( 4 )$$

where U_{α} denotes the utility value of user equipment α; Lᵢ denotes the i-th subarea; ΔT denotes a cycle for selecting user equipments to participate in the sensing data collection; p_{Li}^{t}(α) denotes a probability (e.g. obtained by calculation via formula 2) that the user equipment α is located in the subarea Lᵢ at a predetermined time t; C_{L}_{ᵢ}^{α} denotes a set of the types of sensing data that can be provided by the user equipment α in the subarea Lᵢ; A_{L}_{ᵢ}^{t} denotes a set of the types of sensing data that are recorded in the subarea Lᵢ and are not expired at the predetermined time t. Here, the predetermined time t is the accumulated predetermined time lengths as mentioned previously.

Through the modular arithmetic of |C_{L}_{ᵢ}^{α}−A_{L}_{ᵢ}^{t}|, it is possible to obtain the types of sensing data that the user equipment α can collect in the subarea Lᵢ, that is, the types of sensing data that the user equipment α itself supports and that were previously recorded in the subarea and have expired.

Next, after utility values of multiple equipments are obtained, in step S205, the method 200 selects one or more user equipments from the multiple user equipments for collection of participatory sensing data, based on multiple utility values obtained for the multiple user equipments.

Although it is not illustrated in the figure, in one embodiment, a predetermined threshold may be set and the obtained multiple utility values are compared with the predetermined threshold such that a number of user equipments whose utility values are greater than the predetermined threshold are selected for participatory sensing data collection. It should be understood that the setting of the predetermined threshold depends on a specific application environment. In another embodiment, the obtained multiple utility values are sorted so that a predetermined number of user equipments are selected therefrom for participatory sensing data collection.

Likewise, the method 200 may further comprise: after selecting the user equipments that will participate in sensing data collection, notifying the user equipments of performing the sensing data collection; and receiving and storing sensing data that are collected by the user equipments within the predetermined area. The sensing data may be stored in the sensing data agency 101 for example in the data format as below:

(xᵢ,yᵢ [symbol] d₁,t₁ [symbol] , [symbol] d₂,t₂ [symbol] , . . . , [symbol] (dₙ,tₙ [symbol] ),

where, xᵢ, yᵢ denote the location where the sensing data are collected; tₖ denotes the expiring time of the sensing data; and dₖ denotes the type of the sensing data.

As described above, the sensing data collected in embodiments of the present invention comprise the sensing data related to at least one type of humidity, temperature, air quality, location, brightness, vibration, sound and scene of the area, and are intended to cover the sensing data with any type that various sensors can collect in the future.

Finally, the method 200 ends at step S206, and it can be triggered again by an event, a cycle or a request for execution. For example, after the predetermined time period (or cycle) expires, the method 200 is re-executed for a new round of selection. For another example, when a service provider issues a request, the sensing data agency 101 executes the method 200 to make a selection.

By executing the method 200, it is possible to learn or predict in advance the effect that can be obtained when user equipments participate in sensing data collection within a predetermined area so as to select from multiple candidate user equipments the best or most efficient one or more user equipments for participatory sensing data collection, which facilitates reducing the number of user equipments participating in sensing data collection. Thus, on the one hand, scarce network resources can be effectively and fully used. On the other hand, the cost for collecting sensing data is significantly reduced and the possibility of collecting various types of sensing data is increased, and thus the service providers consuming these sensing data may provide users with lower-cost and various services.

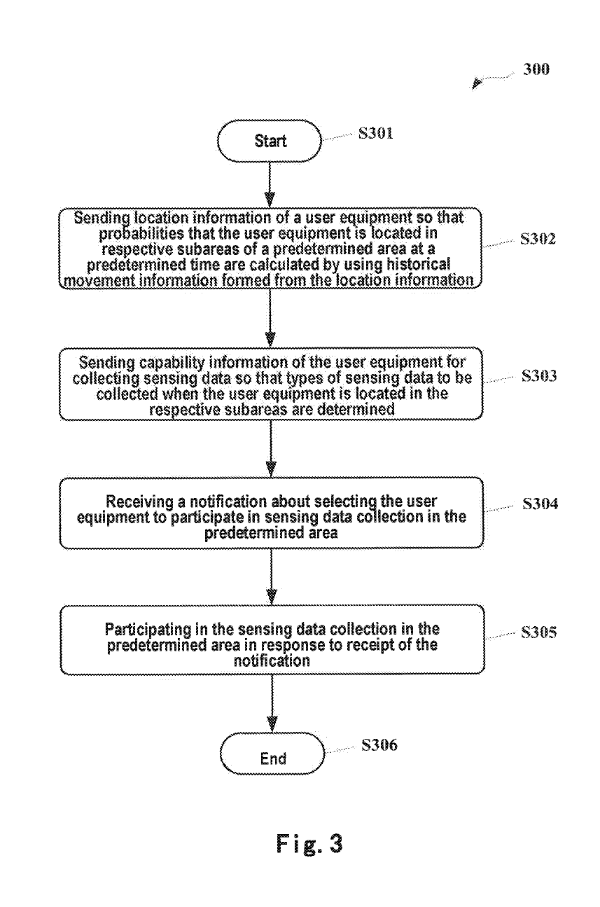

FIG. 3 schematically illustrates a flowchart of a method 300 for participatory sensing data collection according to another embodiment of the present invention. Different from the description from the perspective of, for example, the sensing data agency 101 in FIG. 2, the method 300 describes exemplary embodiments of the present invention from the perspective of user equipments.

As illustrated in FIG. 3, the method 300 starts at step S301. Next, at step S302, the method 300 sends location information of a user equipment so that probabilities that the user equipment is located in respective subareas of a predetermined area at a predetermined time can be calculated by using historical movement information formed from the location information. The historical movement information used herein is the historical movement information as described in conjunction with step S202 in FIG. 2, while the calculation of the probabilities here can also be executed by the way as described in step S202.

After sending the location information, the method 300 proceeds to step S303. Here, the method 300 sends capability information of the user equipment for collecting sensing data so that types of sensing data to be collected when the user equipment is located in the respective subareas can be determined. The capability information used herein refers to the capability information as described in conjunction with step S203 in FIG. 2, while determining types of sensing data to be collected can also be executed by the way as described in step S203.

Then, at step S304, the method 300 receives a notification about selecting user equipments to participate in sensing data collection in the predetermined area, and at step S305, the user equipment will participate in the sensing data collection in the predetermined area in response to receipt of the notification, wherein the selecting is based on a utility value of the user equipment associated with the sensing data collection within the predetermined area, and the utility value is obtained based on the probabilities calculated for the respective subareas and the determined types of sensing data. Likewise, the utility value used herein and the manner for obtaining it may employ the manner as described in the method 200.

Finally, the method 300 ends at step S306.

Although for the purpose of conciseness, descriptions of the same or similar operations in the methods 200 and 300 are omitted when describing the method 300, those skilled in the art shall understand that when executing the steps of the method 300, relevant steps in the method 200 can be correspondingly employed and executed so as to implement selecting multiple user equipments by the sensing data agency.

When executing the method 300, multiple user equipments within the predetermined area will participate in collection of sensing data based on an indication from the sensing data agency 101, which excludes the case in which unnecessary user equipments or user equipments having poor participation effect will participate in sensing data collection. On the one hand, network resource overheads are saved. On the other hand, power of user equipments is increasingly saved, and unnecessary participation in sensing data collection is avoided.

FIG. 4 schematically illustrates an operation diagram of an example for participatory sensing data collection according to embodiments of the present invention. As illustrated in FIG. 4, the sensing area 102 illustrated in FIG. 1 is exemplarily divided into 9 subareas labelled by numbers 1-9, respectively, wherein user equipments 104, 105 and 106 are respectively located in subareas 6, 3 and 8. In addition, in the area 102, a historical movement trace (depicted with a dash and dot line) and a predicted movement trace (depicted with a dashed line) obtained according to the step S202 in the method 200 are exemplarily illustrated. The sensing data that are stored in the database of the sensing data agency 101 and are collected in respective subareas are further illustrated. In order to facilitate description, sensing data with brightness type, vibration type, PM2.5 type and temperature type are expressed by a circle, a square, a star and a triangle, respectively.

How to select user equipments for participatory sensing data collection according to exemplary embodiments of the present invention will be introduced in detail below with reference to FIG. 4 in combination with the description of FIG. 2 or FIG. 3.

Initially, all user equipments (e.g. including user equipments 104-106) within the sensing area 102 may register with the sensing data agency 101, and report to the sensing data agency 101 the types of sensing data that they support for collecting. It should be understood that the registration step is merely exemplary, and in fact, it is possible not to execute such a registration process, but to directly send the collected sensing data to the sensing data agency 101, and the sensing data agency 101 judges their capabilities by executing the method 200 and determines whether to let them participate in sensing data collection.

As described above, a user equipment may report its current location to the sensing data agency 101 periodically or in real time in the sensing area 102 so as to form historical movement information of the user equipment by the sensing data agency 101. The location, for example, may be implemented by the user equipment via its built-in location sensor. The location sensor may implement the location determination by using the technologies/services relating to various location detections, such as a Global Positioning System (GPS), Beidou satellite system, base station triangulation and/or trilateral measurement, Galileo (global mobile system) positioning service, and so on.

After forming the historical movement information of the user equipment, the sensing data agency 101 may predict or calculate probabilities that the user equipment is located in respective subareas 1-9 at a predetermined time. Although the calculation of the probabilities has been described above regarding modeling of a Markov chain, for further understanding of the present invention, a further exemplary introduction will be made below to the calculation of the probabilities.

It is assumed that a user equipment periodically reports its location information to the sensing data agency 101, as understood by those skilled in the art, when the number of reports or observations is big enough, the frequency of an event occurrence approximately equals to the probability of the event occurrence, that is,

$${p}_{ij} = {lim}_{{N}_{i} \to ∞} \frac{{N}_{ij}}{{N}_{i}} \qquad ( 5 )$$

where Nᵢ denotes the number of times a user equipment is transferred out of a subarea Lᵢ; and Nᵢⱼ denotes the number of times a user equipment moves from the subarea Lᵢ to Lⱼ. The sensing data agency 101 may update the P matrix consisting of Pᵢⱼ in real time with the location information reported periodically by the user equipment.

As described above, r_{m,σ} may denote a probability that the stay time of a user equipment in a subarea Lₘ is σ. Likewise, the probability that the stay time of a user equipment in a subarea Lₘ is σ may be calculated based on the location information reported periodically by the user equipment, that is,

r_{m,σ}=Pr{Aₘ=σ} (6)

where a random variable Aₘ denotes the stay time of a user equipment in a subarea Lₘ. Here, in the statistical process of r_{m,σ}, the stay time of the user equipment in the subarea can be discretized. Next, through respective statistics of the number of times the user equipment will stay for different discrete time lengths, the ratio of the number of times corresponding to different discrete time lengths to the total number of times is the probability that the user equipment will stay for corresponding time. For example, the time is discretized to be in a unit of hour. It is assumed that through statistics, the number of times that the user equipment stays in the subarea Lₘ for 1 hour or less is 4, for 1 to 2 hours is 3, and for 2 to 3 hours is 3, then, the total number of times is 10, and the above three cases correspond to the probabilities of 0.4, 0.3 and 0.3, respectively, that is, r_{m,1}=0.4, r_{m,2}=0.3, r_{m,3}=0.3.

With reference to the above described Markov chain, an exemplary explanation will be made below on how to calculate the probabilities that user equipments move among three subareas 1-3 of the sensing area 102 within the cycle ΔT (total 3 time lengths or time slots are assumed) for executing selection of the user equipments to participate in sensing data collection.

It is assumed that the stay time of the user equipment in respective subareas 1, 2 and 3 may be predetermined as 1, 2 or 3 time lengths, and the historical movement traces of the user equipment are assumed to be:

in area 1, the number of times that the stay time is 1 time length is 4; the number of times that the stay time is 2 time lengths is 3; the number of times that the stay time is 3 time lengths is 3;

in area 2, the number of times that the stay time is 1 time length is 2; the number of times that the stay time is 2 time lengths is 1; the number of times that the stay time is 3 time lengths is 7;

in area 3, the number of times that the stay time is 1 time length is 5; the number of times that the stay time is 2 time lengths is 4; the number of times that the stay time is 3 time lengths is 1;

the number of times for transfer from area 1 to subarea 2 is 3, and the number of times for transfer from area 1 to subarea 3 is 7;

the number of times for transfer from area 2 to subarea 1 is 6, and the number of times for transfer from area 2 to subarea 3 is 4;

the number of times for transfer from area 3 to subarea 1 is 4, and the number of times for transfer from area 3 to subarea 2 is 6.

Based on the above historical movement data, the following matrixes can be obtained:

$$matrixes P = ( \begin{matrix}0 & 0.3 & 0.7 \\ 0.6 & 0 & 0.4 \\ 0.4 & 0.6 & 0\end{matrix} ) , R = ( \begin{matrix}0.4 & 0.3 & 0.3 \\ 0.2 & 0.1 & 0.7 \\ 0.5 & 0.4 & 0.1\end{matrix} ) .$$

It is assumed that in the predicting (i.e. 0 time length), the user equipment is located in subarea 2, and the stay time is 2 time lengths, then in the next time length (the first time length), the user equipment will still stay in the subarea 2, and the stay time is 1 time length. In the second time length, user equipment 105 will transfer, and the probability that it transfers to subarea 1 and stays for 1 time length is calculated as p₂₁*r₁₁=0.6*0.4=0.24 based on the above state transfer probability of the modeled Markov chain and according to column 2 of Table 1; the probability that it transfers to subarea 1 and stays for 2 time lengths is calculated as p₂₁*r₁₂=0.6*0.3=0.18; and the probability that it transfers to subarea 1 and stays for 3 time lengths is calculated as p₂₁*r₁₃=0.6*0.3=0.18.

Similarly, it can be obtained by the calculation that the probabilities that a user equipment transfers to subarea 3 and stays for 1, 2 and 3 time lengths respectively are 0.16, 0.12 and 0.12, respectively. In turn, corresponding probabilities that the user equipment is located in respective subareas in the third time length can be respectively calculated based on various situations for the second time length and using the Markov chain. Thus, based on the above method, corresponding probabilities that the user equipment moves among 3 subareas within 3 time lengths can be calculated.

For the purpose of conciseness, a user equipment moving among 3 subareas has been taken as an example above to exemplarily describe how to determine the probabilities that the user equipment is located in respective subareas at predetermined time (i.e. respective time lengths as divided, e.g. the above described first time length, second time length and third time length). According to the teaching here, those skilled in the art can similarly calculate the probabilities that respective user equipments move to all subareas and stay for corresponding time lengths within a predetermined time (i.e. the predetermined time discussed in embodiments of the present invention).

Next, it is possible to determine the types of sensing data that user equipments will collect when moving to subareas. For example, as illustrated in FIG. 4, the user equipment 105 may collect sensing data with vibration, brightness and temperature types. Based on the predicted trace, the user equipment will access subarea 6 and it has never collected sensing data with the vibration type in the subarea 6. Thus, the user equipment 105 may be selected to collect sensing data with the vibration type in the subarea 6. Similarly, based on the prediction, the user equipment 106 will move to subarea 5, and the sensing data with the vibration, brightness and temperature types that are collected in the subarea 5 and stored in the sensing data agency 101 have not expired. Thus, although the user equipment 106 has the capability to collect sensing data with vibration and brightness types, it cannot collect sensing data with the two types.

Next, based on the above determined types of sensing data in combination with the obtained probabilities, it is possible to obtain a utility value that can be obtained by a user equipment in a sensing area 102 if the user equipment participates in sensing data collection when moving to the sensing area 102. For example, it is possible to multiply the obtained probabilities with the number of sensing data types to obtain the utility value.

The above process for obtaining the utility value of the subarea (i.e. the process of probability calculation and sensing data type determination) may be formulated as below:

U_{α}^{L}^{ᵢ}=∫ₜ₌₀^{ΔT}p_{Li}^{t}(α)|C_{L}_{ᵢ}^{α}−A_{L}_{ᵢ}^{t}|dt (7).

In the above formula, U_{α}^{L}^{ᵢ} denotes the utility value that can be obtained when a user equipment α executes sensing data collection in subarea Lᵢ in the cycle ΔT for executing selection of user equipments to participate in sensing data collection. The utility values obtained for respective subareas are summed, that is, it is possible to obtain, via the utility function (4), the utility value that can be obtained if a single user equipment participates in sensing data collection in the entire area 102, and as described in method 200, it is possible to select, by sorting or comparing with a predetermined threshold, multiple appropriate user equipments to participate in sensing data collection in a predetermined area at ΔT time.

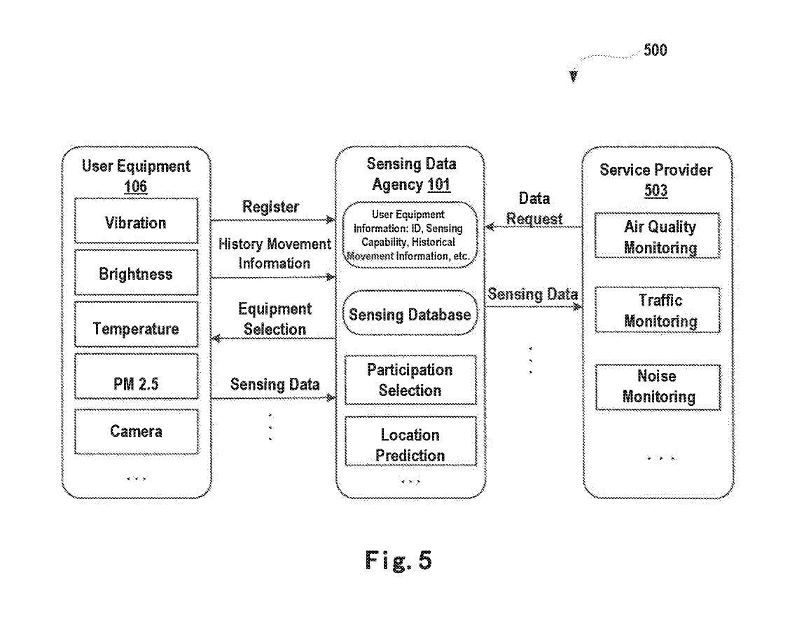

FIG. 5 schematically illustrates an entity interaction diagram 500 among a user equipment 106, a sensing data agency 101 and a service provider 503 for participatory sensing data collection according to embodiments of the present invention. As illustrated in FIG. 5, the user equipment 106 (may also be respective user equipments as illustrated in FIG. 1) may comprise, for example, sensors or inductors having the functions of vibration, brightness, temperature, PM 2.5 and camera, etc. As described above, the user equipment 106 at least can select to register with the sensing data agency 101 and send location information to the sensing data agency 101 in real time, or periodically, or based on a request from the sensing data agency 101 so that the sensing data agency 101 can store in a sensing database the identity ID, the sensing capability and the location information of the user equipment, and can predict, based on these data, the probabilities that the user equipment is located in respective subareas (i.e. locations) and the types of data that can be collected so that a participation selection for the user equipment can be made.

The service provider 503 as a third party may send to a sensing data agency 101 a request for obtaining sensing data, and receive sensing data from the sensing data agency 101. With these sensing data, the service provider may provide users with, for example, air quality monitoring, traffic or communication monitoring and environment (e.g. noise) monitoring, etc. Alternatively, the sensing data agency 101 may periodically send the collected sensing data to the service provider 503. Additionally, the sensing data agency 101 may also provide sensing data to the service provider 503 based on the sensing data reaching certain threshold amount.

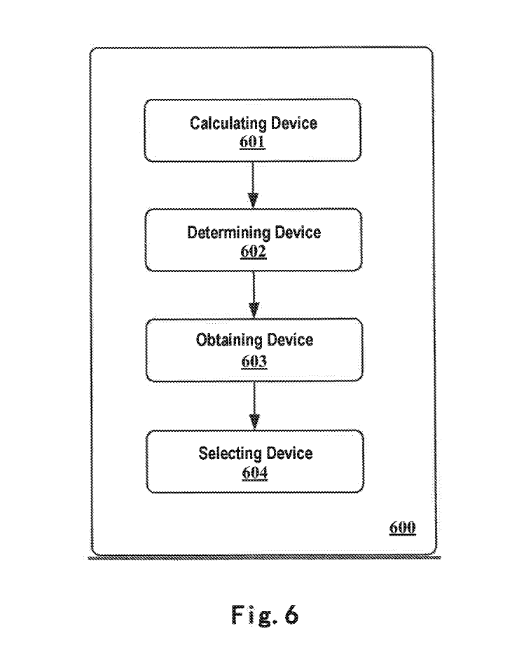

FIG. 6 schematically illustrates a block diagram of an apparatus 600 for participatory sensing data collection according to one embodiment of the present invention. As illustrated in FIG. 6, the apparatus 600 comprises a calculating device 601, a determining device 602 and an obtaining device 603 configured to execute operations for each of multiple user equipments, and a selecting device 604 configured to execute the selection operation for multiple user equipments. In the apparatus 600, the calculating device 601 is configured to calculate probabilities that the user equipment is located in respective subareas of a predetermined area at a predetermined time by using historical movement information of the user equipment. The determining device 602 is configured to determine types of sensing data to be collected when the user equipment is located in the respective subareas based on capability information of the user equipment for collecting sensing data. The obtaining device 603 is configured to obtain a utility value of the user equipment associated with sensing data collection within the predetermined area, based on the probabilities calculated for the respective subareas and the determined types of sensing data. The selecting device 604 is configured to select one or more user equipments from the multiple user equipments for collection of participatory sensing data, based on multiple utility values obtained for the multiple user equipments.

It can be seen that the apparatus 600 may be implemented as or implemented in the sensing data agency 101, and the respective device included therein respectively execute respective steps as described in method 200 so that appropriate user equipments can be selected for participatory sensing data collection.

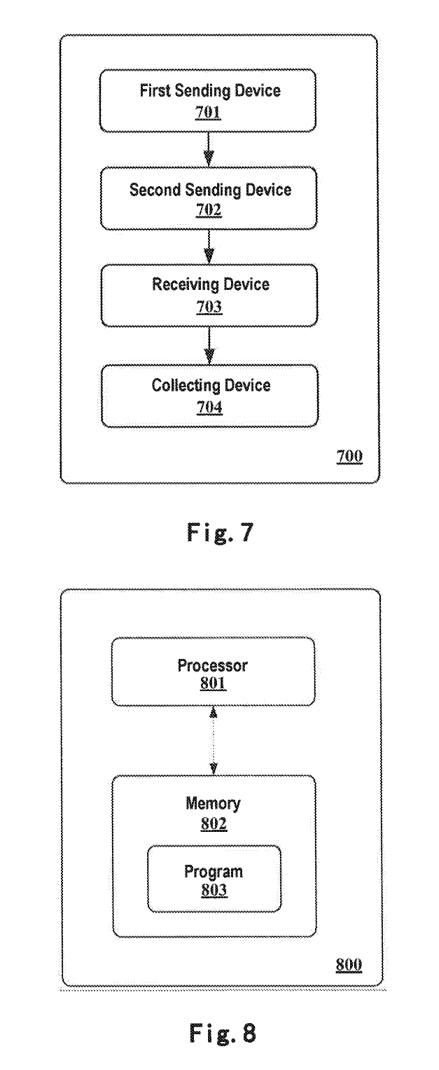

FIG. 7 schematically illustrates a block diagram of an apparatus 700 for participatory sensing data collection according to another embodiment of the present invention. As illustrated in FIG. 7, the apparatus 700 comprises a first sending device 701, a second sending device 702, a receiving device 703 and a collecting device 704. In the apparatus 700, the first sending device 701 is configured to send location information of a user equipment so that probabilities that the user equipment is located in respective subareas of a predetermined area at a predetermined time can be calculated by using historical movement information formed from the location information. The second sending device 702 is configured to send capability information of the user equipment for collecting sensing data so that types of sensing data to be collected when the user equipment is located in the respective subareas can be determined. The receiving device 703 is configured to receive a notification about selecting user equipments to participate in sensing data collection in the predetermined area. The collecting device 704 is configured to participate in the sensing data collection in the predetermined area in response to receipt of the notification, wherein the selecting is based on a utility value of the user equipment associated with the sensing data collection within the predetermined area, and the utility value is obtained based on the probabilities calculated for the respective subareas and the determined types of sensing data.

It can be seen that the apparatus 700 may be implemented as or implemented in a user equipment, and the respective devices included therein respectively execute respective steps as described in method 300 so that appropriate user equipments can be selected to participate in participatory sensing data collection.

FIG. 8 schematically illustrates a block diagram of an apparatus 800 for participatory sensing data collection according to embodiments of the present invention. As illustrated in FIG. 8, the apparatus 800 may comprise at least one processor 801 and at least one memory 802 containing computer program code 803. The processor 801 and the memory 802 are configured to, with the processor 801, cause the apparatus 800 to execute the steps described according to method 200, or execute the steps described according to method 300 so as to implement an optimal selection of user equipments for participatory sensing data collection.

Exemplary embodiments of the present invention are described above with reference to the flowcharts and block diagrams as illustrated in the accompanying drawings. It shall be explained that the method disclosed by embodiments of the present invention may be implemented in software, hardware or a combination of software and hardware. The hardware portion may be implemented by a dedicated logic; the software portion may be stored in a memory and be performed by an appropriate instruction executing system, e.g. a microprocessor, a Personal Computer (PC) or a mainframe. In some embodiments, the present invention is implemented as software, including but not limited to, firmware, resident software, micro-code, etc.

Furthermore, the embodiments of the present invention may further employ the form of a computer program product accessible by a computer-usable or computer-readable medium, and these media provide program code for use by a computer or any instruction executing system or for use in combination with them. For the purpose of illustration, computer-usable or computer-readable mechanism may be any tangible device, which may comprise, store, communicate, broadcast or transmit programs for use by an instruction executing system, apparatus or device, or for use in combination with them.

The medium may be an electric, magnetic, optical, electromagnetic, infrared, or semiconductor system (apparatus or device), or propagation medium. Examples of the computer-readable medium would include the following: a semiconductor or solid storage device, a magnetic tape, a portable computer diskette, a random access memory (RAM), a read-only memory (ROM), a hard disk, and an optical disk. Examples of the current optical disk include a compact disk read-only memory (CD-ROM), compact disk-read/write (CR-R/M), and DVD.

It should be noted that to facilitate understanding of the embodiments of the present invention, some more specific technical details that are well-known to those skilled in the art and may be necessary for implementing embodiments of the present invention are omitted in the above descriptions. The specification of the present invention is provided for illustration and description purposes, rather than exhausting or limiting the present invention to the disclosed form. For those of ordinary skills in the art, many modifications and changes are available.

Thus, selecting and describing the embodiments is to better explain the principle and the actual application of the present invention, and to enable those of ordinary skills in the art to understand that, without departure from the spirit of the present invention, all modifications and variations fall into the protection scope of the present invention limited by the claims.

1-24. (canceled)

25. A method, comprising:
for each of multiple user equipments,
calculating probabilities that the user equipment is located in respective subareas of a predetermined area at a predetermined time by using historical movement information of the user equipment;
determining types of sensing data to be collected when the user equipment is located in the respective subareas, based on capability information of the user equipment for collecting sensing data; and
obtaining a utility value of the user equipment associated with sensing data collection within the predetermined area, based on the probabilities calculated for the respective subareas and the determined types of the sensing data; and
selecting one or more user equipments from the multiple user equipments for collection of participatory sensing data, based on multiple utility values obtained for the multiple user equipments.

26. The method of claim 25, further comprising:
receiving and storing location information about movement of the user equipment among the respective subareas and the capability information for collecting sensing data before calculating the probabilities.

27. The method of claim 25, wherein said calculating probabilities that the user equipment is located in respective subareas of a predetermined area at a predetermined time by using historical movement information of the user equipment comprises:
building a Markov chain model based on the historical movement information, wherein the historical movement information relates to statistical information on location transfer of the user equipment among the respective subareas and stay time of the user equipment in the respective subareas; and
calculating the probabilities that the user equipment is located in the respective subareas of the predetermined area at the predetermined time by using the Markov chain model.

28. The method of claim 25, wherein the types of the sensing data to be collected when the user equipment is located in a subarea are determined based on types of sensing data that can be collected when the user equipment moves to the subarea and types of sensing data that have been collected previously in the subarea and have not expired.

29. The method of claim 25, wherein said selecting one or more user equipments from the multiple user equipments for collection of participatory sensing data, based on multiple utility values obtained for the multiple user equipments further comprises one of the following operations:
comparing each of the multiple utility values with a predetermined threshold; and
sorting the multiple utility values.

30. The method of claim 25, further comprising:
after selecting user equipments that will participate in the sensing data collection, notifying the user equipments to perform the sensing data collection; and
receiving and storing the sensing data that are collected by the user equipments within the predetermined area.

31. The method of claim 25, wherein execution of the method is triggered by an event, a cycle or a request.

32. The method of claim 25, wherein the utility value is obtained with a formula as below:
$${U}_{α} = {\sum }_{{L}_{i}} {\int }_{t = 0}^{Δ T} {p}_{Li}^{t} ( α ) \vert {C}_{{L}_{i}}^{α} - {A}_{{L}_{i}}^{t} \vert d t$$
where U_{α} denotes the utility value of a user equipment α; Lᵢ denotes the i-th subarea; ΔT denotes a cycle for selecting user equipments to participate in the sensing data collection; p_{Li}^{t}(α) denotes a probability that the user equipment α is located in the subarea Lᵢ at a predetermined time t; C_{L}_{ᵢ}^{α} denotes a set of the types of sensing data that can be provided by the user equipment α in the subarea Lᵢ; A_{L}_{ᵢ}^{t} denotes a set of the types of sensing data that are recorded in the subarea Lᵢ and are not expired at the predetermined time t.

33. The method of claim 25, wherein the sensing data comprise sensing data that are collected by the user equipment and relate to at least one type of humidity, temperature, air quality, location, brightness, vibration, sound and scene of the respective subareas.

34. An apparatus, comprising:
at least one processor and at least one memory containing computer program code;
the processor and the memory configured to, with the processor, cause the apparatus to at least execute, for each of multiple user equipments:
calculate probabilities that the user equipment is located in respective subareas of a predetermined area at a predetermined time by using historical movement information of the user equipment;
determine types of sensing data to be collected when the user equipment is located in the respective subareas, based on capability information of the user equipment for collecting sensing data; and
obtain a utility value of the user equipment associated with sensing data collection within the predetermined area, based on the probabilities calculated for the respective subareas and the determined types of the sensing data; and
the processor and the memory configured to, with the processor, cause the apparatus to select one or more user equipments from the multiple user equipments for collection of participatory sensing data, based on multiple utility values obtained for the multiple user equipments.

35. The apparatus of claim 34, wherein the processor and the memory are configured to, with the processor, cause the apparatus to at least execute:
receive and storing location information about movement of the user equipment among the respective subareas and the capability information for collecting sensing data before calculating the probabilities.

36. The apparatus of claim 34, wherein the processor and the memory are configured to, with the processor, cause the apparatus to at least execute:
build a Markov chain model based on the historical movement information, wherein the historical movement information relates to statistical information on location transfer of the user equipment among the respective subareas and stay time of the user equipment in the respective subareas; and
calculate the probabilities that the user equipment is located in the respective subareas of the predetermined area at the predetermined time by using the Markov chain model.

37. The apparatus of claim 34, wherein the processor and the memory are configured to, with the processor, cause the apparatus to at least execute:
determine the types of the sensing data to be collected when the user equipment is located in a subarea, based on types of sensing data that can be collected when the user equipment moves to the subarea and types of sensing data that have been collected previously in the subarea and have not expired.

38. The apparatus of claim 34, wherein the processor and the memory are configured to, with the processor, cause the apparatus to at least execute:
compare each of the multiple utility values with a predetermined threshold; and
sort the multiple utility values.

39. The apparatus of claim 34, wherein the processor and the memory are configured to, with the processor, cause the apparatus to at least execute:
after selecting user equipments that will participate in sensing data collection, notify the user equipments to perform the sensing data collection; and
receive and store the sensing data that are collected by the user equipments within the predetermined area.

40. The apparatus of claim 34, wherein execution of the apparatus is triggered by an event, a cycle or a request.

41. The apparatus of claim 34, wherein the utility value is obtained with a formula as below:
$${U}_{α} = {\sum }_{{L}_{i}} {\int }_{t = 0}^{Δ T} {p}_{Li}^{t} ( α ) \vert {C}_{{L}_{i}}^{α} - {A}_{{L}_{i}}^{t} \vert d t$$
where U_{α} denotes the utility value of a user equipment α; Lᵢ denotes the i-th subarea; ΔT denotes a cycle for selecting user equipments to participate in the sensing data collection; p_{Li}^{t}(α) denotes a probability that the user equipment α is located in the subarea Lᵢ at a predetermined time t; C_{L}_{ᵢ}^{α} denotes a set of the types of sensing data that can be provided by the user equipment α in the subarea Lᵢ; A_{L}_{ᵢ}^{t} denotes a set of the types of sensing data that are recorded in the subarea Lᵢ and are not expired at the predetermined time t.

42. The apparatus of claim 34, wherein the sensing data comprise sensing data that are collected by the user equipment and relate to at least one type of humidity, temperature, air quality, location, brightness, vibration, sound and scene of the respective subareas.

43. An apparatus, comprising:
at least one processor and at least one memory containing computer program code;
the processor and the memory configured to, with the processor, cause the apparatus to at least execute:
send location information of a user equipment so that probabilities that the user equipment is located in respective subareas of a predetermined area at a predetermined time are calculated by using historical movement information formed from the location information;
send capability information of the user equipment for collecting sensing data so that types of sensing data to be collected when the user equipment is located in the respective subareas are determined;
receive a notification about selecting the user equipment to participate in sensing data collection in the predetermined area; and
participate in the sensing data collection in the predetermined area in response to receipt of the notification,
wherein said selecting is based on a utility value of the user equipment associated with the sensing data collection within the predetermined area, and the utility value is obtained based on the probabilities calculated for the respective subareas and the determined types of the sensing data.
